(19) United States
(12) Patent Application Publication
(10) Pub. No.: US 2025/0363291 A1
(43) Pub. Date: Nov. 27, 2025

(54) Document Generation Using Multi-modal Feedback for AI Language Models

(71) Applicant: A0 Systems, Inc., Palo Alto, CA (US)

(72) Inventors: Nathan Ackerman, Palo Alto, CA (US); Austin Riedel, Tarzana, CA (US)

(73) Assignee: A0 Systems, Inc., Palo Alto (CA)

(21) Appl. No.: 19/213,929

(22) Filed: May 20, 2025

Related U.S. Application Data
(60) Provisional application No. 63/650,666, filed on May 22, 2024.

(51) Int. Cl. G06F 40/166; G06F 40/117

(52) U.S. Cl. CPC G06F 40/166; G06F 40/117

(57) ABSTRACT

Techniques relating to document generation using multi-modal feedback for an AI language model is disclosed. A method for document generation includes receiving user input, generating a prompt configured to frame content for subsequent steps of a workflow session, providing an incremental feedback user interface, generating a divergent list of content options using the AI language model, generating a convergent list of content options using the incremental feedback and the AI language model, receiving various user approval at various steps of a workflow session, and generating a final structured output corresponding to the document. Drafts of the document may be provided indicating redlines or markups. A multi-agent review process may be selected and implemented.

### CROSS-REFERENCE TO RELATED APPLICATIONS

This application claims the benefit of U.S. Provisional Patent Application No. 63/650,666 entitled “Multi-modal Incremental Feedback for AI Language Models,” filed May 22, 2024, the contents of which are hereby incorporated by reference in their entirety.

### BACKGROUND OF THE INVENTION

This disclosure generally relates to the use of artificial intelligence (“AI”) for generation of documents, and more particularly to an improved multi-modal feedback approach for a language model AI tool.

AI language models, such as OpenAI's GPT, have transformed how we generate documents by synthesizing text that can match a variety of styles and contexts. To effectively use such a model, it's crucial to provide detailed and specific instructions that align with the user's desired outcome. This means clearly outlining the purpose, tone, structure, and any content-specific details a user may want included in the ultimate output of the model. For instance, to generate a business proposal, a user may want to specify the industry, the objectives of the proposal, key points that need to be covered, and the desired tone (formal, persuasive, etc.). This preparation helps the model grasp the scope and nuances of the task, leading to more accurate and relevant outputs.

Additionally, understanding the settings and parameters available in the language model can greatly enhance the quality of the generated documents. Most advanced models allow a user to adjust settings such as the response length, creativity level or ‘temperature,’ and the presence of specific keywords or phrases. For example, setting a lower temperature results in more predictable and conservative text output, which might be ideal for formal documents like reports or emails. Conversely, a higher temperature encourages the model to generate more creative and diverse text, suitable for brainstorming sessions or creative writing. Familiarity with these settings allows users to fine-tune the model's responses, ensuring the output is not only high quality but also tailored to the specific needs of the document.

However, for average users who may not be as familiar with the intricacies of using an artificial intelligence language model, several drawbacks can make the experience challenging and potentially less effective. Language models often require specific instructions and parameters to generate useful outputs. For users without a technical background, understanding how to set these parameters (like ‘temperature,’ ‘max tokens,’ etc.) can be daunting. Without this knowledge, users might not be able to tailor the AI's responses to their specific needs, resulting in outputs that are either too generic or off-topic. Current approaches typically engage a user in a “chat” based interaction between a user and the language model tool, with the user issuing a query or request, sometimes with limited context and parameters, and the model generating output, receiving user feedback on the output, typically in a textual response, and iterating over the process until an acceptable output is generated. This approach is time-consuming, inefficient, and does not always result in a usable output. A particularly difficult challenge is how to provide natural language (textual or spoken) feedback to the model in order to have the model adjust its output towards the user's desired result.

Addressing these challenges involves creating more user-friendly interfaces for feedback generation and allowing the use of complex and highly targeted context and parameter settings without user involvement, with no need to have specific understanding of the intricacies of using an artificial intelligence language model. These improvements could make AI tools more accessible and more efficient for the average user to leverage the use of AI tools in everyday business tasks.

### BRIEF SUMMARY OF THE INVENTION

A system and method are disclosed for document generation using multi-modal feedback for AI language models. According to some embodiments, a method for document generation using multi-modal feedback for AI language models may include: receiving a user input comprising a request to generate a document; generating a prompt configured to frame content for subsequent steps of a workflow session for obtaining multi-modal feedback for the AI language model; receiving a first user approval of the prompt; providing an incremental feedback user interface; generating a divergent list of content options using the AI language model; receiving a second user approval of the divergent list; generating a convergent list of content options using the incremental feedback and the AI language model; and generating a final structured output corresponding to the document. In some examples, the incremental feedback comprises user prioritization feedback. In some examples, the method also includes prompting the AI language model to generate an enhanced list of content items for the document being generated; and receiving a third user approval of the enhanced list of content items. In some examples, the method also includes prompting one or more specialized AI models to generate area-specific feedback on a current draft of the document; presenting a set of diverse perspectives options based on the area-specific feedback for selection by the user; and receiving multi-agent review feedback indicating a selection of none, one, or more of the set of diverse perspectives options for inclusion in the document. In some examples, the method also includes further comprising receiving a multi-agent selection input indicating a request to activate none, one, or more of the specialized AI models. In some examples, the one or more specialized AI models comprises one, or a combination, of a legal domain specialized AI model, a technical domain specialized AI model, and a creative domain specialized AI model. In some examples, the one or more specialized AI models comprises a specialized AI model for each of a set of different potential consumers.

In some examples, the document comprises one of a technical/engineering requirements document, a press release FAQ, a conceptual document, a technical specification, an implementation plan, and other business document. In some examples, generating the final structure output comprises applying, by the AI language model, a final layer of formatting to organize the document into a structured format suitable for storage and retrieval. In some examples, the final layer of formatting comprises one, or a combination, of tagging a section with metadata, indexing content for searchability, and converting the document into a format. In some examples, the format is suitable for a digital archive.

In some examples, the method also includes storing the final structured output. In some examples, the method also includes storing a session log comprising feedback received during the workflow session. In some examples, the method also includes training the AI model using the session log. In some examples, the method also includes generating a document draft comprising one, or a combination, of a redline, a markup, and a comment.

According to some embodiments, a user interface for an AI language model tool for document generation may include: a tool for text manipulation; an overview of a workflow for a document generation session; a window configured to present one or both of a document draft and a final structured output; and a control window comprising a control element. In some examples, the window is further configured to present one, or a combination, of a divergent list of content options, a convergent list of content options, multi-agent model selection options, diverse perspectives options, and/or other feedback options. In some examples, the tool comprises one, or a combination, of a highlighting tool, an editing tool, and a commenting tool. In some examples, the editing tool comprises a plurality of text formatting options for providing emphasis and/or de-emphasis. In some examples, the overview of the workflow indicates a current step of the document generation session. In some examples, the control element comprises one or more buttons configured to allow a user to provide approval and non-approval feedback associated with steps of the workflow.

According to one embodiment of the present invention, a multi-modal feedback user interface is provided for an AI language model. In one embodiment, the user interface is provided as a document-based interface for a language model that enhances user interaction through a structured, incremental feedback mechanism that simplifies the process of generating high-quality documents. According to one embodiment, the user interface breaks down the document creation into discrete, manageable steps, allowing users to provide detailed feedback that continuously refines the AI's output. In one embodiment, familiar document editing tools like highlighting and commenting are incorporated, making the system intuitive for all users. Highly structured prompts minimize the initial input required from the user. According to one embodiment, a multi-agent review process provides diverse perspectives that users can choose to include or disregard with respect to the document being created. In one embodiment, the end result is a polished, expert-level document that appears to require minimal user effort but is actually a product of detailed interaction, tailored precisely to user specifications and stored in a structured format for easy retrieval and further processing. This process not only makes the technology accessible to users without technical expertise but also significantly enhances the accuracy and relevance of the generated content.

### BRIEF DESCRIPTION OF THE SEVERAL VIEWS OF THE DRAWINGS

FIG. 1A-1C is a flow chart illustrating an exemplary document generation workflow process using an AI language model interface according to embodiments of the invention.

FIG. 2 is a diagram illustrating a user interface for providing multi-modal feedback to an AI language model according to embodiments of the invention.

FIG. 3A is a simplified block diagram of an exemplary computing system configured to perform steps of the method illustrated in FIGS. 1A-1C and to implement the user interface illustrated in FIG. 2, in accordance with one or more embodiments.

FIG. 3B is a simplified block diagram of an exemplary distributed computing system implemented by a plurality of the computing devices, in accordance with one or more embodiments.

The figures depict various example embodiments of the present disclosure for purposes of illustration only. One of ordinary skill in the art will readily recognize form the following discussion that other example embodiments based on alternative structures and methods may be implemented without departing from the principles of this disclosure and which are encompassed within the scope of this disclosure.

### DETAILED DESCRIPTION OF THE INVENTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The above and other needs are met by the disclosed methods, a non-transitory computer-readable storage medium storing executable code, and systems for a user interface to provide multi-modal feedback to a language model AI tool, for example, for generation of documents. According to one embodiment, to enhance the usability and effectiveness of a language model interface, especially for users who may not be well-versed in AI or technical jargon, a more user-friendly and interactive document-based interface is provided. This interface incorporates incremental user feedback to refine and improve outputs from the AI model dynamically.

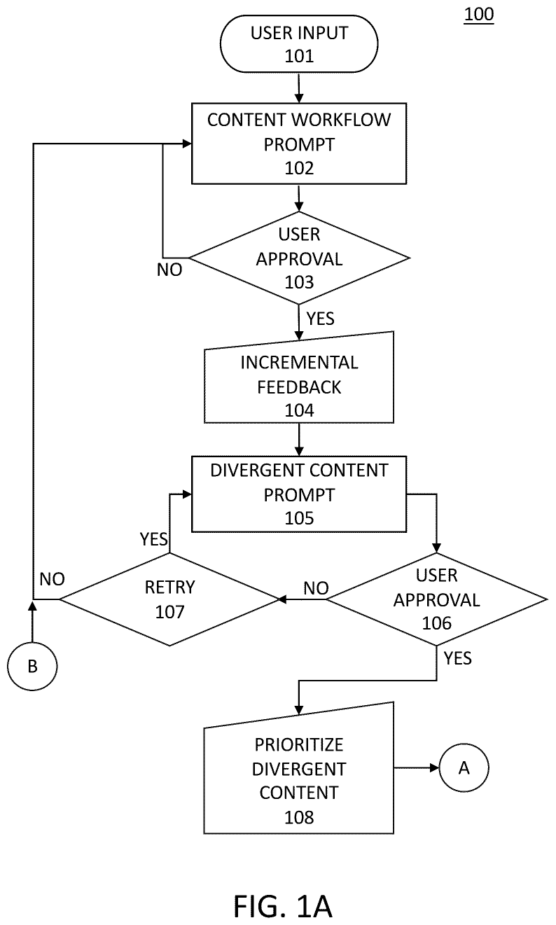

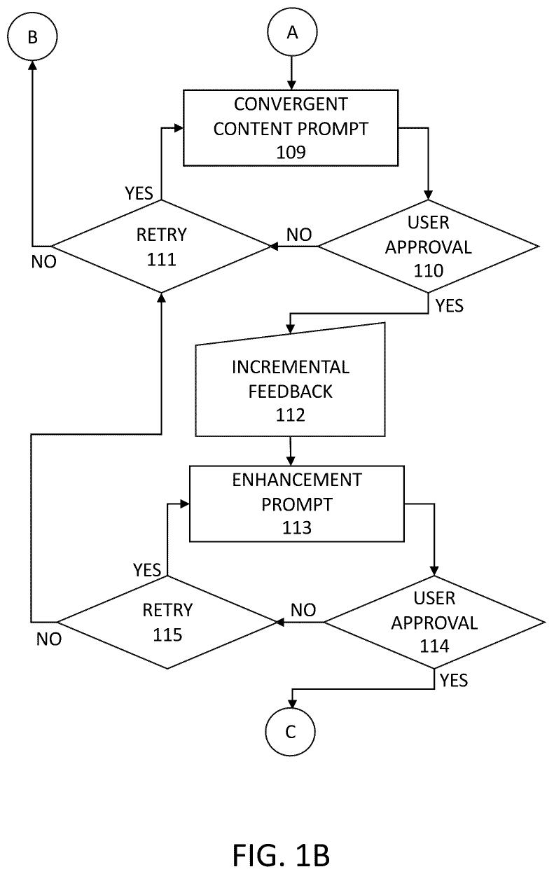

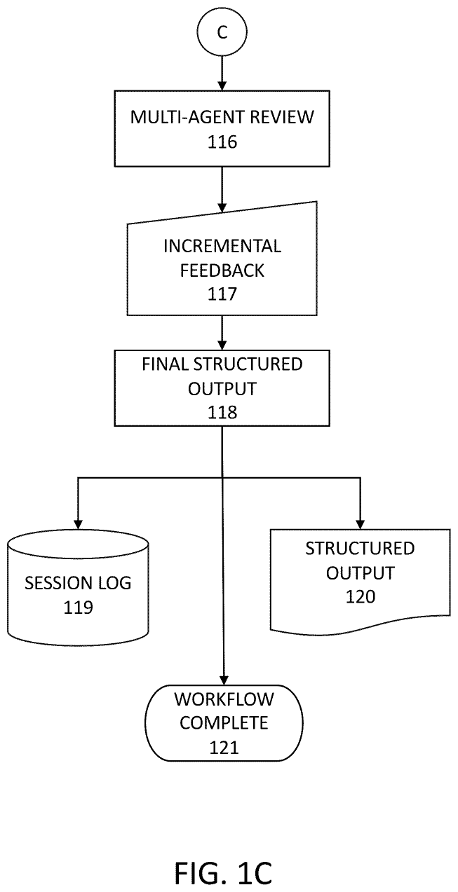

Referring now to FIG. 1A-1C, a flow chart illustrating an exemplary document generation workflow process using an AI language model interface is provided according to embodiments of this disclosure. According to one embodiment, the task of generating a complete document 100 is broken down into a workflow with discrete steps. The number of steps in any given workflow can vary depending on the intended output document and any number of optional features that may be desired. Each step is designed to tackle a portion of the document or a specific aspect of the content, making it easier for users to provide focused and detailed feedback as each step.

In one embodiment, FIG. 1A shows that a method is provided that receives user input 101 with a request to generate business document. The user input 101, for example stating a particular need or problem, is used to generate (e.g., select, produce, put together, propose) a prompt 102 for the AI language model. The prompt 102 (i.e., content workflow prompt) is used to frame the content for the subsequent steps in the workflow (e.g., for a document creation session). For example, in one embodiment, the following expert system prompt may be provided to the model:
{
   role: “system”,
   content: ‘You are an expert product manager who is very creative and capable of identifying solutions.
You are capable of considering multiple stakeholder needs, competing priorities and constrained resources and coming up with novel and compelling solutions to problems.
Because you are an expert product manager, you know that the key to creating a great solution is to first really understand the problem.
I would like to work with you to solve a problem.’,
   },
   {
      role: “user”,
      content: ‘The first thing I think that we should work on is understanding what it is like to experience the problem.
My problem is: $ {seed?·problem}.
Describe what it is like in the eyes of the people who experience this problem. What does it feel like?
As we think about what it is like to struggle with this, we should describe this from the perspective of the person, people or organizations that struggle with it. For example, “I hate it when I am unable to . . . ” or “Companies struggle to” are great.
We want to make sure we capture the experience, so consider this problem over multiple time horizons, including daily, weekly, monthly, and unexpectedly.
Provide your response in JSON format that conforms to
{
“title”: <descriptive title>,
“summary”: [
   <summary sentence>,
   <summary sentence>,
   <summary sentence>
],
“dailyChallenges”: [
   {
      “title”: <challenge title>,
      “description”: <quotation describing the challenge using quote>
   },
   {
      A person of ordinary skill in the art will understand that different prompts may be generated for different intended industries, objectives of a document, key points that need to be covered, desired tone (formal, persuasive, etc.), and the like. The initial user input can guide the specific elements of the prompt as needed. Notably, any format suitable to the specific language model may be used in order to generate prompt 102.

According to an aspect of embodiments of the system, developers may create a library of template prompts that cover various document types and content requirements. The AI may use natural language processing to interpret the minimal input from the user and select the most appropriate prompt from the library. In one embodiment this selection process is enhanced with machine learning to improve prompt selection over time based on past user interactions and feedback. The prompt library may be prepared for different intended document types with corresponding context settings for the language model. The prompts may be based on relevant experience and expertise in the various industries addressed by the system.

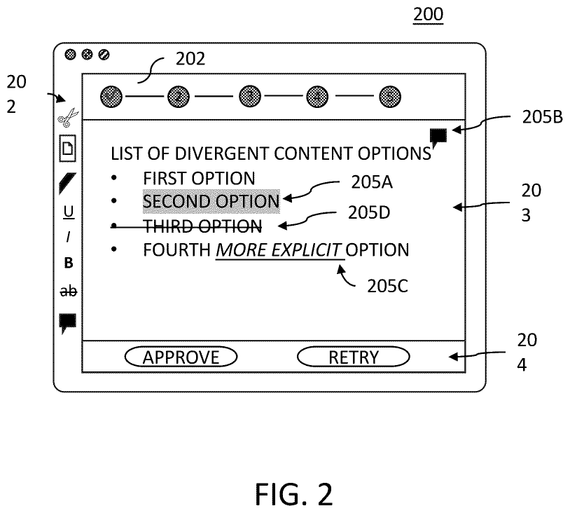

According to this embodiment, the user is given an opportunity to approve 103 the generated content workflow or to regenerate the content workflow prompt 102. This loop may be repeated as many times as necessary until the user is satisfied with the output of the model at this step. If the content is approved 103 by the user, the user is then presented with a user interface through which incremental enrichment feedback can be provided 104. User interfaces according to this aspect of the invention are further described with reference to FIG. 2 below. Based on the user feedback, the method prompts 105 the AI language model to generate a divergent list of content options for the intended document (e.g., business document). For example, according to one embodiment, the following exemplary prompt may be provided based on the prior user input:
{
   role: “user”,
   content: ‘Now that we know what it is like for someone who is dealing with the problem, please organize everything into a list of specific pain points that capture the pain experienced from the problem as we have identified.
When considering the pain points, be sure to focus on the things that I have expressed specific interest in and avoid the things that I have said I am uninterested in.
We should also consider pain points beyond the ones that I have expressed interest in, especially if they are related or tangential to ones I am interested in.
Use your judgment as an expert product manager, obsessed with high quality deliverables above all, to come up with the pain points that have the biggest impact and present them in priority order of the biggest pain first.
Not all pian points impact people the same way. Some pain points are a mild annoyance, such as having to press multiple buttons on a screen to achieve the outcome desired, while other pain points are causes significant detriments to a person, people, or organization such as not being able to access life saving medicine or being preventing from accomplishing their ultimate goal entirely.
Group the pain points accordingly in three groups: most severe, medium severity, mild severity.
Provide your response in JSON format that conforms to

```
{
″title″: <Descriptive title>,
″summary″: [
  <summary sentence>,
  <summary sentence>,
  <summary sentence>
]
″mostSeverePainPoints″: [
  {
    ″title″: <title>,
    ″description″: <description>
  }
],
″mediumSeverityPainPoints″: [
  {
    ″title″: <title>,
    ″description″: <description>
  }
],
″mildPainPoints″: [
  {
    ″title″: <title>,
    ″description″: <description>
  }
],
}‘,
      },
```

According to one aspect in some embodiments, the system implements a machine learning classifier that guides the workflow based on the relevant user input. The classifier can determine the appropriate document, content generation workflow, and selection of prompts based on its training and/or prior sessions of the method. The classifier identifies the nature of the user's initial input-whether it's a problem statement, a tactical query, or another form- and selects an appropriate workflow. This ensures that the system is always aligned with the user's immediate needs, enhancing the relevance and efficacy of the AI support. In one embodiment, an adaptive classifier is provided by training a machine learning model to recognize the nature of a user's input (e.g., a problem statement, a query). The system then automatically selects and initiates the appropriate workflow. Over time, this classifier learns from user corrections to improve its accuracy, making the system more responsive and relevant to individual user needs.

The divergent list initially may provide the user with a mechanism to guide the document generation by selecting or providing relevant feedback from the options presented. The user can approve the divergent content list 106 or retry 107 the divergent content prompt 105. This loop may be repeated as many times as necessary until the user is satisfied with the output of the model at this step. Once approved 106, the user may be given an opportunity to prioritize 108 the divergent content options, for example through incremental feedback and/or prioritization feedback.

Now referring to FIG. 1B, based on the received user prioritization feedback from 108, the method generates 109 a prompt for the AI model to generate a convergent list or content narrowing down the options for the document generation based on the user feedback. Once again, the user is given the option to approve 110 the converged content options or retry 111 the convergent content prompt 109. This loop may be repeated as many time as necessary until the user is satisfied with the output of the model at this step. The system can then accept additional incremental user feedback 112 on the convergent content options. Based on the user feedback, the system prompts 113 the AI model to enhance the existing list of content items in the document being generated. The method again provides a loop allowing the user to approve 114 the enhanced content or to retry 115 the enhancement prompt 113 until the user is satisfied with the model's output. At this point, the model's output is close to a final draft of the document being generated. Once the user approves the output 114, the model begins the finalizing steps.

Now referring to FIG. 1C, in one embodiment the method includes an optional multi-agent review step 116. The multi-agent review process 116 provides diverse perspectives that users can choose to include or disregard with respect to the document being created (e.g., a set of diverse perspectives options may be presented to a user based on area-specific feedback, as described herein). In one embodiment, the multi-agent review process includes various prompts to the model to review and provide area-specific feedback on the current draft of the document based on the different members of the intended audience of the final document. For example, several specialized AI model, each focusing on different domains (such as legal, technical, creative), are integrated to provide document feedback.

According to these embodiments, users can activate none, one, or more of these agent models (e.g., provide multi-agent selection input using a user interface presenting multi-agent model selection options) to receive specialized feedback or content suggestions. The system would manage the integration of this feedback, presenting it to the user in a coherent manner where they can easily accept or reject suggestions (e.g., multi-agent review feedback comprising a selection of none, one, or more of the set of diverse perspectives options for inclusion in the document). For example, in one embodiment, a technical specification for a product is generated using the incremental feedback workflow and the multi-agent review process 116 includes AI model agents for different potential consumers of the final document, such as, a technical lead, a marketing product lead, an engineering manager, and the like. Different agents are generated with the appropriate persona or roll and corresponding context to analyze and provide feedback on the draft document from each of the agents. This optional step generates various feedback outputs, for example as redlines, markups, and/or comments on the actual document draft. The user can then review each of the feedback options and provide his/her own incremental feedback to the multi-agent review changes/comments for the language model to consider in generating the final structured output 118.

If multi-agent feedback is not used, the workflow can go directly to the final structured output 118. In embodiments the final structured output can be any type of business document, such as for example, a technical/engineering requirements document, a press release FAQ, a conceptual document, a technical specification, an implementation plan, or the like. At this stage, the AI model applies a final layer of formatting to organize the document into a structured format suitable for storage and retrieval. This includes, for example, tagging sections with metadata, indexing content for searchability, and converting the document into formats like PDF or XML that are suitable for digital archives. Before completing the workflow session, the structured output is stored 120 and a session log with the feedback generated during the session is also stored 119. Session logs are subsequently used to further train and refine the AI model to produce more accurate divergent and convergent content options for the relevant document type. In some embodiments, the session logs can be used to personalize the model to a particular user or set of users. Once the final structured output document is generated and stored the workflow terminates 121.

While in the description of the method and system illustrated in FIGS. 1A-1C the examples provided refer to a user, the system and method is applicable to a collaborative environment where multiple users can participate in the workflow. In some embodiments, a hierarchical approval process is implemented, allowing different levels of approval and feedback at each workflow step. For example, a manager user can have a final approval authority at one or more steps of the workflow that may cause the workflow to proceed or to retry the pertinent step.

Referring now to FIG. 2, an exemplary user interface design implementation for an AI language model tool is provided according to embodiments of the disclosure. According to one aspect of these embodiments, the interface implementation is a document-centric interface, similar to traditional word processing interfaces, which are familiar to even the least technically sophisticated users. The user interface 200 features tools 201 for text manipulation like highlighting, editing, and adding comments, allowing users to interact with the AI outputs in a way that feels intuitive and straightforward. The user interface can provide an overview of the workflow 202 for a document generation session. In some examples, the overview of the workflow 202 may illustrate the current step of the process (i.e., document generation session). The user interface includes a window 203 where a current draft of the document is output to the user for the user to review and provide incremental feedback. In some examples, window 203 also may be configured to present a divergent list of content options, a convergent list of content options, multi-agent model selection options, diverse perspectives options, and/or other feedback options, as described herein. The user interface also may include a control window 204 with control elements, such as buttons, for the user to control the workflow process.

The user interface according to these embodiments provides the user with an intuitive approach to give feedback to the AI tool in a document-centric format. Using this approach, instead of a conventional chat-bot conversational exchange, the user provides incremental feedback to the language model's presentation of initial drafts in a document-like format based on minimal user inputs. Users can then modify the content directly within the document window 203, such as by highlighting sections 205A that need changes or are incorrect, adding comments 205B, rewriting sections 205C, providing emphasis/de-emphasis 205D using text formatting options, such as bolding, underlining, italicizing, crossing, or the like. For example, according to one embodiment, by a first touch (i.e., click, double-click, swipe, drag, or other selection indication), the user may provide highlighting 205A to indicate to the model that the selected content should be emphasized in subsequent drafts of the output. By a second touch, the user can de-emphasize content by striking through 205D, indicating to the model that this content should be de-emphasized in subsequent drafts of the output. De-emphasis on content can be implemented in a cumulative way, such that the probability of that content being included in subsequent drafts decreases for each de-emphasis selection from the user. Finally, in a third touch, the user may provide an edit 205C, directly modifying the content of the current draft to provide to the model more explicit changes desired in the next draft of the output. In embodiment, edited content 205C is automatically emphasized to ensure that the direct user feedback is integrated into subsequent drafts of the output document.

According to this aspect of embodiments of the disclosure, the user input through this multi-modal incremental feedback interface directly informs the model's subsequent outputs. Each user interaction adjusts the context for the next piece of content generated by the AI. This could be in response to user edits, rejections, or emphasis on certain parts of the text, providing the model with a rich feedback loop that continuously refines the output. According to one embodiment, the feedback mechanism is achieved by integrating real-time text analysis where the AI detects changes made by the user and suggests on-the-fly improvements or alternatives. Each user action, whether adding, deleting, marking, emphasizing, commenting, or otherwise modifying text, triggers the model to re-evaluate the context and to re-generate updated content suggestions. Implementation in one embodiment involves setting up event listeners in the software to monitor changes and dynamically update the model's context upon detection of user feedback.

In one embodiment, the user interface mimics familiar text editing software like Microsoft Word, Google Docs, Pages, or similar software to lower the learning curve for users already familiar with those word processing tools. The appropriate software being mimicked may be selected by the user based on the user's own familiarity with the available options. In one embodiment, a a web-based application or a desktop app is provided with a rich text editor at its core, providing tools such as text formatting, spell check, and undo/redo options. This familiar environment would encourage more user interaction and make it easier for users to navigate and manipulate text directly, which is crucial for providing feedback to the AI. The text editor is interfaced to the language model to implement the desired workflow.

According to one aspect of embodiments of the invention, to minimize user effort and maximize output relevance, the system uses highly structured prompt sequences that activate with minimal user input. These prompts guide the AI at each step of the workflow to generate content that adheres closely to the user's goals, reducing the likelihood of irrelevant or inaccurate content. According to one embodiment, the document creation process is divided into specified stages, each focusing on a different aspect of the document (e.g., introduction, body, conclusion). The interface guides users from one stage to the next, with the AI generating content for each segment based on the structured feedback received. Backend logic manages the workflow states and ensures that feedback from earlier stages influences content generation in subsequent ones.

Outputs at each step are formatted to match expert systems, ensuring that the content not only reads well but also aligns with professional standards for the corresponding type of document. For example, in embodiments, formatting is automated according to expert systems using templates with predefined styles and formats. The AI automatically applies these templates based on the document type or user selections. Additionally, AI-driven tools suggest document layouts that improve readability and professional appearance based on current best practices in document design. This formatting helps in reviewing and editing the content to meet specific criteria or standards. In addition, in embodiments, a version control system is provided within the document editor to track changes over time. Each version can reflect adjustments made by the user, allowing the AI to understand the evolving context and refine its subsequent outputs based on these insights. This ensures that each iteration is better aligned with the user's intentions.

In some embodiments, the interface includes tools like mind mapping, brainstorming modules, and the ability to quickly draft and rearrange sections of text. These tools help users expand and refine their ideas. The AI suggests connections between different sections or ideas, helping to guide the user's thought process towards a more focused and structured output. This facilitates the narrowing down of broad ideas into more focused, actionable tasks, helping users organize and articulate complex thoughts.

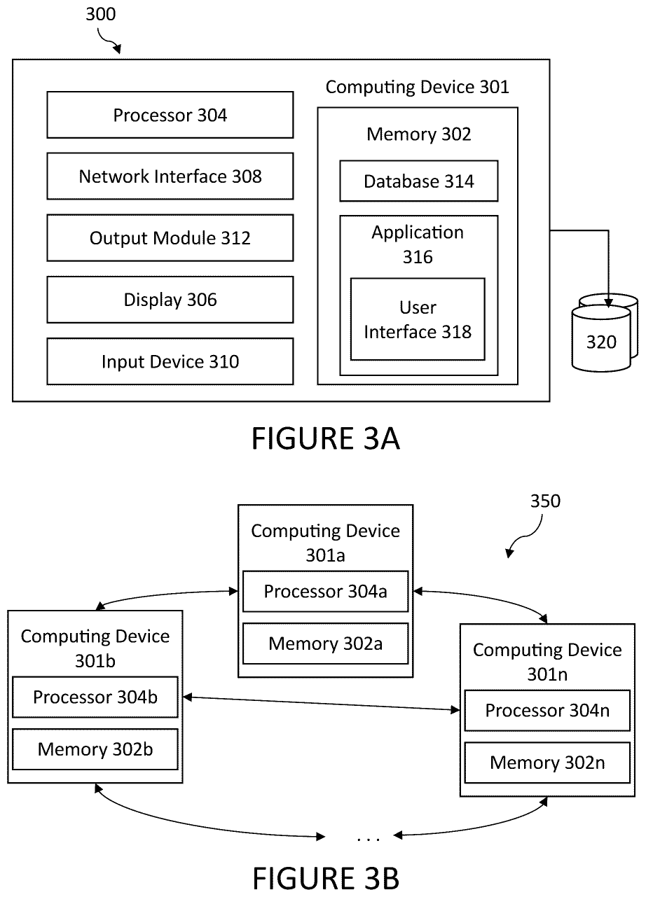

FIG. 3A is a simplified block diagram of an exemplary computing system configured to perform steps of the method illustrated in FIGS. 1A-1C and to implement the user interface illustrated in FIG. 2, in accordance with one or more embodiments. In one embodiment, computing system 300 may include computing device 301 and storage system 320. Storage system 320 may comprise a plurality of repositories and/or other forms of data storage, and it also may be in communication with computing device 301. In another embodiment, storage system 320, which may comprise a plurality of repositories, may be housed in one or more of computing device 301. In some examples, storage system 320 may store document data, session data (e.g., session logs), AI models (e.g., AI language models, specialized AI models), features, instructions, programs, and other various types of information as described herein. This information may be retrieved or otherwise accessed by one or more computing devices, such as computing device 301, in order to perform some or all of the features described herein. Storage system 320 may comprise any type of computer storage, such as a hard-drive, memory card, ROM, RAM, DVD, CD-ROM, write-capable, and read-only memories. In addition, storage system 320 may include a distributed storage system where data is stored on a plurality of different storage devices, which may be physically located at the same or different geographic locations (e.g., in a distributed computing system such as system 350 in FIG. 3B). Storage system 320 may be networked to computing device 301 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 301 also may include a memory 302. Memory 302 may comprise a storage system configured to store a database 314 and an application 316. Application 316 may include instructions which, when executed by a processor 304, cause computing device 301 to perform various steps and/or functions, as described herein. Application 316 further includes instructions for generating a user interface 318 (e.g., user interface 200, and other graphical user interfaces (GUI)). Database 314 may store various algorithms and/or data, including AI models and data regarding documents and document generation, session logs, metadata, among other types of data. Memory 302 may include any non-transitory computer-readable storage medium for storing data and/or software that is executable by processor 304, and/or any other medium which may be used to store information that may be accessed by processor 304 to control the operation of computing device 301.

Computing device 301 may further include a display 306, a network interface 308, an input device 310, and/or an output module 312. Display 306 may be any display device by means of which computing device 301 may output and/or display data. Network interface 308 may be configured to connect to a network using any of the wired and wireless short range communication protocols described above, as well as a cellular data network, a satellite network, free space optical network and/or the Internet. Input device 310 may be a mouse, keyboard, touch screen, voice interface, and/or any or other hand-held controller or device or interface by means of which a user may interact with computing device 301. Output module 312 may be a bus, port, and/or other interface by means of which computing device 301 may connect to and/or output data to other devices and/or peripherals.

Various configurations of system 300 are envisioned, and various steps and/or functions of the processes described herein may be shared among the various devices of system 300 or may be assigned to specific devices.

FIG. 3B is a simplified block diagram of an exemplary distributed computing system implemented by a plurality of the computing devices, in accordance with one or more embodiments. System 350 may comprise two or more computing devices 301a-n. In some examples, each of 301a-n may comprise one or more of processors 304a-n, respectively, and one or more of memory 302a-n, respectively. Processors 304a-n may function similarly to processor 304 in FIG. 3A, as described above. Memory 302a-n may function similarly to memory 302 in FIG. 3A, as described above.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms, flow charts, and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following.

What is claimed is:

1. A method for document generation using multi-modal feedback for an AI language model comprising:
receiving a user input comprising a request to generate a document;
generating a prompt configured to frame content for subsequent steps of a workflow session for obtaining multi-modal feedback for the AI language model;
receiving a first user approval of the prompt;
providing an incremental feedback user interface;
generating a divergent list of content options using the AI language model;
receiving a second user approval of the divergent list;
generating a convergent list of content options using the incremental feedback and the AI language model;
generating a final structured output corresponding to the document.

2. The method of claim 1, wherein the incremental feedback comprises user prioritization feedback.

3. The method of claim 1, further comprising:
prompting the AI language model to generate an enhanced list of content items for the document being generated; and
receiving a third user approval of the enhanced list of content items.

4. The method of claim 1, further comprising:
prompting one or more specialized AI models to generate area-specific feedback on a current draft of the document;
presenting a set of diverse perspectives options based on the area-specific feedback for selection by the user; and
receiving multi-agent review feedback indicating a selection of none, one, or more of the set of diverse perspectives options for inclusion in the document.

5. The method of claim 4, further comprising receiving a multi-agent selection input indicating a request to activate none, one, or more of the specialized AI models.

6. The method of claim 4, wherein the one or more specialized AI models comprises one, or a combination, of a legal domain specialized AI model, a technical domain specialized AI model, and a creative domain specialized AI model.

7. The method of claim 4, wherein the one or more specialized AI models comprises a specialized AI model for each of a set of different potential consumers.

8. The method of claim 1, wherein the document comprises one of a technical/engineering requirements document, a press release FAQ, a conceptual document, a technical specification, an implementation plan, and other business document.

9. The method of claim 1, wherein generating the final structure output comprises applying, by the AI language model, a final layer of formatting to organize the document into a structured format suitable for storage and retrieval.

10. The method of claim 9, wherein the final layer of formatting comprises one, or a combination, of tagging a section with metadata, indexing content for searchability, and converting the document into a format.

11. The method of claim 10, wherein the format is suitable for a digital archive.

12. The method of claim 1, further comprising storing the final structured output.

13. The method of claim 1, further comprising storing a session log comprising feedback received during the workflow session.

14. The method of claim 13, further comprising training the AI model using the session log.

15. The method of claim 1, further comprising generating a document draft comprising one, or a combination, of a redline, a markup, and a comment.

16. A user interface for an AI language model tool for document generation comprising:
a tool for text manipulation;
an overview of a workflow for a document generation session;
a window configured to present one or both of a document draft and a final structured output; and
a control window comprising a control element.

17. The user interface of claim 16, wherein the window is further configured to present one, or a combination, of a divergent list of content options, a convergent list of content options, multi-agent model selection options, diverse perspectives options, and/or other feedback options.

18. The user interface of claim 16, wherein the tool comprises one, or a combination, of a highlighting tool, an editing tool, and a commenting tool.

19. The user interface of claim 18, wherein the editing tool comprises a plurality of text formatting options for providing emphasis and/or de-emphasis.

20. The user interface of claim 16, wherein the overview of the workflow indicates a current step of the document generation session.

21. The user interface of claim 16, wherein the control element comprises one or more buttons configured to allow a user to provide approval and non-approval feedback associated with steps of the workflow.
